(19) United States
(12) Patent Application Publication
(10) Pub. No.: US 2005/0263978 A1
(43) Pub. Date: Dec. 1, 2005

(54) Bicycle having frame geometry, elliptical pedaling path, and seat configuration to increase efficiency and comfort

(76) Inventor: Steven G. Ascher, Kentfield, CA (US)

Correspondence Address: JOHNSON & STAINBROOK, LLP, 3558 ROUND BARN BLVD., SUITE 203, SANTA ROSA, CA, 95403, US

(21) Appl. No.: 10/955,499

(22) Filed: Sep. 29, 2004

Related U.S. Application Data
(60) Provisional application No. 60/507,209, filed on Sep. 29, 2003.

(51) Int. Cl. B62K 15/00

(52) U.S. Cl. 280/261

(57) ABSTRACT

A bicycle having a frame geometry, elliptical pedaling system, and seat design and configuration which, in combination, moves the rider's body weight rearward relative to its location in conventional bicycle designs, increases the hip joint range of motion and maximum knee flex experienced during pedaling, increases the distance over which the rider's knee is directly over the pedal spindle during pedaling, provides a seating platform from which to brace and push during leg extension, and thereby increases overall efficiency and rider comfort.

### CROSS REFERENCE TO RELATED APPLICATIONS

The present application claims priority of the filing date of U.S. Provisional Patent Application No. 60/507,209 filed Sep. 29, 2003.

### BACKGROUND OF THE INVENTION

1. Technical Field

The present invention relates generally to bicycles, and more particularly to high performance ergonomically advantageous bicycles, and more particularly still to a bicycle having a frame geometry, crank and pedal system, and seat design, that cooperate to provide substantially increased comfort and efficiency.

2. Background Discussion of Related Art

Bicycle technology has reached a stage of maturity in which innovations that truly advance the art are rare and almost always quite exotic. Some of the more well known recent advances include: lightweight and aerodynamic frames, spokeless wheel sets, each of which are made possible through the use of composite materials and high-strength lightweight alloys; gear shifting mechanisms integrated into brake levers; and lightweight disc brakes (now commonly available). These are but a few of the many revolutionary changes in the art—each represents more than an admirable oddity that has no practical application; rather, they comprise improvements that have changed industry standards. The present invention rises to this level of achievement. It includes developments in frame geometry and design for collapsible bicycles, drive train design, elliptical pedaling systems, and seat design and saddle positioning systems. A brief discussion of the background art of each of these elements will illustrate the degree to which the present invention may be patentably distinguished.

Vastly more people would enjoy cycling if it were a more comfortable experience. However, the frame geometry employed in conventional bicycles causes discomfort to many, if not most riders, either immediately or on long rides. One overriding element governs bicycle frame geometry and how a rider's body weight is balanced between the seat, the pedals, and the handlebar: that element is the power stroke. The most effective transfer of power to the pedals is achieved when the knee is directly above the pedal spindle. When a conventional bicycle is fitted the starting point is to position the knee over the pedal spindle when the crank arm is forward and parallel to the ground. This is shown in FIG. 1A, illustrating the conventional position and geometry for a tall rider, and FIG. 1C, illustrating the conventional position for a short rider. This geometry creates a seat tube angle (STA) exceeding 72 degrees as measured from the horizontal plane. In this position, when the rider leans forward, he shifts substantial body weight forward to the handlebars. This places considerable strain on the wrists, neck and shoulders, causing fatigue on long rides and potential injury if the strain is repetitive.

It would be desirable, therefore, to provide a bicycle having increased comfort without sacrificing pedaling efficiency. To make a bicycle more comfortable while also improving performance, the frame geometry and pedal system must increase the distance over which the knee is positioned over the pedal spindle while also reducing the seat tube angle. FIGS. 1B and 1D illustrate such a frame geometry, which is made possible by employing an elliptical pedaling system. FIG. 1B shows a bicycle having a frame geometry adapted for a tall rider, while FIG. 1D shows a frame geometry for a short rider. Each illustration shows how an elliptical pedaling motion can be combined with a frame having a seat tube angle of under 69 degrees to substantially increase the distance over which the knee is positioned over the pedal spindle. This reduced STA places more weight rearward of the pedals, thereby reducing the strain placed upon the wrists, neck and shoulders.

Furthermore, increased power is obtained by increasing the range of motion of the hip joint while reducing knee flex. The frame geometries and pedal paths shown in FIGS. 2A, 2B, 2C and 2D, correspond to those of FIGS. 1A, 1C, 1B, and 1D, respectively. In FIG. 2A the hip joint range of motion (HM) is 38 degrees and the maximum knee flex (KF) is 121 degrees. In FIG. 2C HM is 48 degrees and KF is 114 degrees, increasing hip joint motion 26 percent while decreasing knee flex by over 6 percent. Similarly for a small rider in FIG. 2B, where HM is 43 degrees and KF is 128 degrees, while in FIG. 2D, HM is 61 degrees and KF is 125 degrees, increasing hip joint motion 42 percent while decreasing knee flex by over 2 percent. In these examples the shorter rider's crank is 165 mm, and the taller rider's crank is 180 mm, and in each case the ellipse has a perimeter equal to a crank length of 178.7. The shape and angle of the ellipse may be changed to further enhance these results with a bias towards either power or reduction of knee flex, according to rider needs and preferences.

The use of an elliptical pedaling motion on a bicycle is not a new idea. In fact, documents dating back to 1890 may be found which illustrate such ideas. Of the many proposed ways of creating an elliptical pedaling path, the most successful approach places the lowest demands on strength of materials. This approach entails the use of two separate mechanisms, one for each foot. Each mechanism employs two crank arms, a roller chain and two sprockets. Such a mechanism is shown in FIG. 3, which is an illustration from Fahrrad & Radfahrer by Wilhelm Wolf published, 1890 in Leipzig (reprinted in 1988 by Harenberg, ISBN 3-88379-106-1).

There are two disadvantages that have kept this particular mechanism from favorable and widespread acceptance in the market place—backlash and resulting wide pedal spacing. The rise and fall of roller chain links as they engage a sprocket do not permit constant tension to be maintained and thus backlash is inherent in systems employing roller chains. This resulting backlash is undesirable because as the rider's pedals cross top and bottom dead center the span tension changes, snapping the chain in the other direction and imparting an undesirable impact to the rider. In a conventional bicycle drive train the front chain rings are positioned between the frame and the crank arms. Current chain based elliptical mechanisms place the mechanism in the same relative position as the crank arms. Since the width of the mechanism is substantially wider than a normal crank arm the resulting distance between pedals separates the rider's feet and legs to an undesirable and uncomfortable width. Too much separation between the feet forces the rider to push the pedal outwardly as well as downwardly, or otherwise to shift weight laterally in an effort to keep the knee directly over the pedal spindle, and either approach compromises both the ergonomic and biomechanical aspects of the motion.

It would therefore be advantageous to provide a bicycle having an elliptical pedal system that eliminates the problem of chain backlash while keeping the rider's feet an anatomically desirable distance apart.

With the seat tube angle of current bicycle geometry, the rider must sit on top of a seat with cutaways for the legs leaving a small area with high pressure placed upon it. This is the cause of many complaints and medical problems. Accordingly, it would be desirable to provide a seat that cooperates with a reduced STA and an elliptical pedaling system to provide a means to shift body weight rearward, thus adding support for the body in a manner similar to leaning against a wall with the legs out and only the buttocks contacting the wall.

Furthermore, when mounting a bicycle having a conventional frame geometry, the rider must tilt the bicycle toward him, swing his leg over the seat, position his pelvis bones upon the seat or stand in front of the seat, push off the ground with one foot while pushing the properly positioned pedal with the other foot, find a balance point, and only then begin riding. On a traditional bicycle, to make this procedure easier many new riders typically adjust the seat so they may stand flat footed on the ground while seated and begin riding from this vantage point. Unfortunately this places tremendous stress upon the knees and will tire a rider quickly. It would be desirable, therefore, to have a frame geometry and seat design that cooperated to allow a rider to lift a foot over a bottom bracket lower than knee height, stand in front of the seat, place one foot upon a pedal, lean back against a seat, and push with the pedal foot, thus immediately providing sufficient forward momentum to balance and slide up the seat, and thereafter to move further up the seat to achieve better leg extension.

In an urban setting riders are not always able to ride in the best conditions. To access desirable bicycle routes and paths or to avoid inclement weather, it is frequently necessary to transport a bicycle in a car, or on a bus, train or ferry. It is also increasingly desirable to store a bicycle as compactly as possible in the home or garage. Further, if the bicycle were to be sold through the Internet rather than through a bicycle shop, it is advantageous to have a bicycle that may be shipped fully assembled in a UPS box. Current folding bicycles introduce joints which weaken the frame, add to the overall weight, and reduce the aesthetic appeal of a bicycle. It would also be desirable, then, to provide a bicycle with a collapsible bicycle frame that also successfully addresses the problems set forth in the immediately preceding paragraphs.

Numerous non-circular and elliptical pedaling systems for bicycles and other human powered vehicles have been proposed and tested. Exemplary systems include U.S. Pat. No. 6,017,295, to Eschenbach, which discloses a recumbent mobile exercise apparatus with variable intensity pedal operation in which the pedals are guided through an oblong or elongate curve motion during operation by a seated operator.

U.S. Pat. No. 5,419,572, to Stiller et al., teaches a bicycle drive that converts linear or elliptical reciprocating pedaling motion to rotary motion of the spindle and the wheels. A pair of sun gears are mounted concentric with the crank spindle; a pair of planet gears revolve around the sun gear. A set of inboard crank arms between the spindle and the planet gear are fixed to the spindle and rotatably connected to the planet gear. Outboard crank arms are secured to the planet gears to rotate along with them. Pedals are mounted on the outboard crank arms. As the inboard arms rotate the planet gears and the outboard arms, the outboard arms rotate in the opposite direction to the inboard arms. If the outboard arms are longer than the inboard arms then the pedals will move in an elliptical path in a backwards direction.

U.S. Pat. No. 4,193,324 to Marc, teaches a crank design integrating an elliptical sprocket and a planetary-type gear drive which creates an elliptical pedal path. The gear arrangement is housed in a circular frame mounted on a conventional bicycle frame and seat configuration.

U.S. Pat. No. 5,433,680, to Knudsen, describes a complex elliptical path pedaling system that employs two mutually perpendicular intersecting guideways with a circular drive member pivotally attached at its center to a follower, mounted for reciprocal movement within the first guideway. A second follower is pivotally attached to the circular drive member at a predetermined radial distance from the center of said drive member for reciprocal movement in the second guideway. Pedal crank arms are attached to each drive member to rotate it about the center. As the drive member rotates, the reciprocating movements of the two followers in the perpendicular guideways cause the drive member to move back and forth in the path of the first guideway. A pedal crank attached to the reciprocating drive member follows an elliptical path.

U.S. Pat. No. 4,019,230 to Pollard describes a mechanism which uses one way roller clutches or ratchets that provide a reciprocating arcuate movement of the pedals. Each pedal is driven through a portion of a stroke only. By locking the two units together, the two pedals can be placed at 180.degree. from one another so that the usual rotary motion is possible.

Elliptical pedaling paths have also been effected by variable-length or differential crank mechanisms. Exemplary systems include those taught in U.S. Pat. No. 5,207,119 to Garneau and U.S. Pat. No. 5,816,600 to Matsuura. Swiss Pat. No. 553,055 teaches a differential crank mechanism in which each crank arm is constructed in two parts, an inner crank arm and an outer crank arm, rotatably joined at an intermediate shaft. According to Rob Price, [Human Powered Vehicles, Abbot & Gordon, eds. (Human Kinetics Pub, 1995), pp. 176-177], the outer crank arm is timed to the inner crank arm using a 2:1 ratio chain or a three-gear-step up from the bottom bracket. The outer arm rotates in a direction that is the reverse of the inner arm, and this creates an elliptical pedal path. Price also notes an alternative method of producing an elliptical pedal path by using a crank mechanism with oscillating arms. (Id.)

Numerous solutions to bicycle seating problems have also been proposed, among them including: U.S. Pat. No. 6,575,529 to Yu, teaches a seat having a seat base, two side seat members slidably and respectively mounted on the left and right sides of the seat base such that each of the side seat members slide left and right on the seat base to provide space between the buttocks. A front seat member is mounted on the front side of the base. The seat assembly can be adjusted in width to fit the physical characteristics of the rider.

U.S. Pat. No. 6,554,355 shows a seat having a seat base plate mounted at the upper end of the seat post. Two rider supports are pivotally mounted on the base plate and capable of pivoting in relation to the centerline of the seat. A cushion is supported on the base plate, and rounded cushions are secured to each extension. The cushion for the base plate has a rounded periphery in contact with the rounded surface of each cushion on the rider supports. The cushion for the base plate has a rearward margin defining a shoulder that absorbs rearward forces applied by the right ilium and the left ilium of the rider's pelvis. The rider support cushions and the base plate cushion collectively form a crease to accommodate the rider's ischium extremity.

U.S. Pat. No. 6,450,572 to Kuipers shows a hard saddle made of closed cell polyurethane foam covering a rigid base plate. Soft cell foam material lies above the hard foam material and provides the rider with a comfortable cushion surface and runs completely across the saddle from the nose to the rear. An air hole may be formed through the bicycle saddle near its center to provide ventilation and reduce pressure applied to the perineal nerves. Pockets of polyurethane gel above the soft foam material near the rear of the saddle respond to the shifting position of the rider so as to more evenly spread the rider's weight over the top of the saddle.

U.S. Pat. No. 6,302,480 to Hall, discloses a bicycle seat that distributes the rider's weight away from the groin area of the rider's body toward the buttocks and legs. The central extension found in conventional bicycle seats is eliminated and replaced with front and rear central indentations that are formed in the seat to reduce the longitudinal length in the central portion of the bicycle seat and minimize contact between the bicycle seat and the groin area of a rider's body. An extended lateral seating surface distributes the rider's weight outward from the central seating area of the rider's body.

U.S. Pat. No. 6,224,151 to McMullen, Jr., teaches a saddle in which the rear one third of the saddle is an elevated level platform that supports the cyclist's weight on the ischial tuberosities, while the saddle surface forward of the platform steps down and continuously slopes downward towards the saddle's nose.

Examples of collapsible frame designs include U.S. Pat. No. 6,267,401 to De Jong, discloses a foldable bicycle having a frame divided into halves connected with frame-coupling means that enable the halves to pivot relative to each other about a vertical axis. Frame-locking means allows the halves to be locked into an operating configuration. The saddle arm pivots about a horizontal axis, and a forward pivotal movement of the saddle arm unlocks the frame-coupling means to permit the frame halves to fold.

U.S. Pat. No. 5,590,895 to Hiramoto, describes a collapsible bicycle frame having front frame member and a rear frame member that supports a rear wheel. The front and rear members are hinged for rotation about a first axis that is vertical when the bicycle is upright. The head tube is rotatably supported on the front frame member, and a fork stem is rotatably supported in the head tube. A locking mechanism selectively locks the head tube to the front frame and a second locking mechanism which selectively locks the front frame and rear frame.

U.S. Pat. No. 5,772,227 to Michail teaches a foldable bicycle having a front frame including the front wheel, the handle bar and the seat, and a rear frame with the rear wheel, cogged wheel, a pair of pedals and a transmission element. The front and rear frames are joined with a coupling having bearings.

U.S. Pat. No. 6,595,536 to Tucker discloses a collapsible bicycle comprising a down tube pivotally connected to a horizontal stay at the mid-section. It is also slidably connected to steering and seat assemblies. The various members are in a slightly canted configuration to provide a structure sufficiently rigid to bear a rider while allowing the vehicle to be collapsed to a compact size for storage. The vehicle is collapsed into the form of an “X” by bringing the wheels into a side-by-side position.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

To create a more comfortable bicycle that performs well, many inventive elements are employed. These elements viewed individually may appear as separate patentable items, but it is the holistic use of these inventions which are required to create a truly comfortable high performance bicycle.

In accordance with the present invention, to solve the above-described problems several inventive solutions are employed: To substantially reduce backlash in chain based elliptical pedal systems, the chain is replaced by a flexible belt, preferably a synchronous belt (i.e., a timing belt, positive-drive belt, or high torque drive belt), although a silent chain (i.e., an inverted tooth chain) may also be employed. (While the preferences have mechanical advantages, the inventive aspects of the drive are not affected by using a standard V-belt or a cogged belt.) This approach permits constant tension to be maintained and backlash can be minimized. To reduce the distance between the pedals to a very desirable level only achieved by the finest road bikes, a chain ring/belt sprocket is placed at or near the center of the frame either between two members or within the frame itself. To further reduce the width of the elliptical mechanism and protect the belt/silent chain from dirt the belt/silent chain and sprockets may be contained within the cranks themselves. Using this method singularly permits the use of this mechanism on a traditional bicycle with a single chain ring to an inline sprocket on a fixed gear or internal hub producing a wide but somewhat reasonable distance between pedals. FIG. 4 illustrates such an elliptical mechanism. This drive train is then connected to a mid-drive which brings the chain back out to the desired chain line. There are many additional benefits to such an arrangement that make it beneficial outside the context of introducing an elliptical drive train: (1) chain/belt speed may be increased in two stages allowing a set of chain rings to be smaller and shift more easily; (2) more gears can be introduced without further widening the distance between pedals; (3) an enclosed hub based transmission may be moved from the rear wheel to the mid-drive; (4) the chain/belt may be enclosed in the frame protecting the chain/belt and the rider; (5) and the bike may be folded at the pivot point of the mid-drive without effecting chain/belt tension.

As noted, the seat tube angle of conventional bicycle geometry places the rider atop a seat in an uncomfortable and potential injurious manner. FIGS. 5A-C illustrate a novel seat that supports a rider from behind with substantially more surface area than a traditional seat, significantly reducing pressure. Additionally, just as a wall doesn't have to be a specific height to support people of all sizes this seat allows a rider to begin pedaling and then slide to the most comfortable position. This gives a rider a greater sense of security being able to rise to a comfortable position as well as slide down when coming to a stop. This overcomes another large barrier to riding—getting on the seat. To mount a traditional bike, the rider must tilt the bicycle toward him, swing his leg over the seat, position his pelvis bones upon the seat, push off the ground with one foot while pushing the properly positioned pedal with the other foot, find a balance point and begin riding. With the new seat design the rider simply stands in front of the seat, places a foot upon a pedal, pushes off and when balanced, slides up the seat. As the rider becomes more comfortable he may push further up the seat to achieve better leg extension. On a traditional bicycle, to make this experience easier many new riders typically adjust the seat so they may stand flat footed on the ground while seated and begin riding from this vantage point. Unfortunately this places tremendous stress upon the knees and will tire a rider quickly. Additional inventive aspects of this seat design are the reduction of parts possible by combining seat post, seat bracket, rails and seat perimeter. The seating surface may also be suspended from the perimeter in such a way that the rider is not substantially in contact with it. This lends itself to the use of breathable fabrics providing better ventilation than traditional bicycle seats.

To overcome the problems of conventional frame folding designs, the present invention includes a novel frame design having frame members that connect and pivot relative to one another in a way that does not compromise structural integrity, overall weight, or the aesthetic appeal of the bicycle. FIG. 5D illustrates a folding mechanism which uses only the existing suspension pivot of the mid-drive, an innovative twin top tube configuration that allows the folded tire to swing over the bike and nestle into the frame. Additionally the inventive front end assembly, shown in detail in FIGS. 7A-D, orients the stem and one side of the fork such that they bypass the head tube and telescope into each other. This allows the handlebars to be adjusted to a wide variety of heights and become very compact. The fork may be one sided or incorporate a shock absorber into the other side using the telescoping tube side for alignment.

It is therefore an object of the present invention to provide a new and improved bicycle having a frame geometry, seat position, and pedal path that increase rider comfort without sacrificing pedaling efficiency.

It is a further object of the present invention to provide a bicycle having a frame geometry and pedal path that increases the distance over which the rider's knee is positioned over the pedal spindle while pedaling.

While accomplishing the foregoing objects, it is yet another object of the present invention to provide a bicycle with a reduced seat tube angle.

It is still another object of the present invention to provide a new and improved bicycle having a frame geometry, seat configuration, and pedaling system in which increased power is obtained by increasing the range of motion of the hip joint while reducing knee flex.

A further object or feature of the present invention is to provide a new and improved bicycle having an elliptical pedaling system used in conjunction with a frame geometry having a reduced seat tube angle.

It is yet another object of the present invention to provide a bicycle having an elliptical pedaling system that eliminates the problem of chain backlash without increasing the distance between a rider's feet to an anatomically and biomechanically disadvantageous distance.

An even further object of the present invention is to provide a novel bicycle having a comfortable seat design and configuration that works with a reduced seat angle and elliptical pedaling system to shift a rider's weight rearward.

Still another object of the present invention is to provide an improved bicycle that includes a seat that adds support for the rider such that the rider may employ the seat for support in pushing off during leg extension during pedaling.

Yet another object of the present invention is to provide a bicycle having frame geometry, pedaling system, and seat configuration that positions the rider against the seat in manner similar to that of leaning against a wall with only the buttocks contacting the wall.

A still further object of the present invention is to provide an improved bicycle having a frame geometry, pedaling system, and seat design that cooperate to allow a rider to more easily mount and begin riding the bicycle.

Another object of the present invention is to provide a novel bicycle having a collapsible frame having frame elements that do not compromise frame strength, bicycle operating efficiency or riding comfort, and that is pleasing in appearance.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as definitions of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the national patent office(s) and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is schematic side view in elevation showing the seat tube angle of a prior art bicycle having a conventional frame geometry and pedaling system and adapted for use by a tall rider;

FIG. 1B is a schematic side view in elevation showing a bicycle having a reduced seat tube angle and elliptical pedaling system and adapted for use with a tall rider;

FIG. 1C is a schematic side view in elevation showing the seat tube angle of a prior art bicycle having a conventional frame geometry and pedaling system and adapted for use with a short rider;

FIG. 1D is a schematic side view in elevation showing a bicycle having a reduced seat tube angle and elliptical pedaling system and adapted for use by a short rider;

FIG. 2A is a schematic side view in elevation showing the hip joint range of motion and maximum knee flex of a tall rider riding a prior art bicycle having a conventional frame geometry and pedaling system;

FIG. 2B is a schematic side view in elevation showing the hip joint range of motion and maximum knee flex of a short rider riding a prior art bicycle having a conventional frame geometry and pedaling system;

FIG. 2C is a schematic side view in elevation showing the hip joint range of motion and maximum knee flex of a tall rider riding a bicycle having a reduced seat tube angle and elliptical pedaling system;

FIG. 2D is a schematic side view in elevation showing the hip joint range of motion and maximum knee flex of a short rider riding a bicycle having a reduced seat tube angle and elliptical pedaling system;

FIG. 3 is a perspective view of a prior art elliptical pedaling system;

FIG. 4A is side view in elevation of the elliptical drive mechanism of the present invention;

FIG. 4B is a cross-sectional front view in elevation showing the elliptical drive mechanism as viewed along Section line B-B of FIG. 4A;

FIG. 4C is a cross-sectional side view in elevation showing the elliptical drive mechanism as viewed along Section line C-C of FIG. 4B;

FIG. 4D is a partial exploded perspective view, showing the operational elements of one side of the elliptical drive mechanism;

FIG. 5A is a schematic side view in elevation of the bicycle of the present invention, showing the seat and handlebars adjusted and configured for a tall rider;

FIG. 5B is a schematic side view in elevation of the bicycle of the present invention, showing the seat and handlebars adjusted and configured for a short rider;

FIG. 5C is a schematic front perspective view of the inventive bicycle showing the handlebars and seat set up as in FIG. 5B;

FIG. 5D is a schematic perspective view showing the inventive bicycle in a collapsed configuration;

FIG. 6 is a schematic side view in elevation showing the bicycle of the present invention;

FIG. 6A is a cross-sectional rear view of the mid-drive and final drive as view along Section line A-A of FIG. 6;

FIG. 6B is an upper right rear perspective view of the mid-drive and final drive shown in FIG. 6A;

FIG. 7A is a front view in elevation of the front end assembly of the bicycle of the present invention, shown with the stem extended for a tall rider;

FIG. 7B is a side view in elevation of the front end assembly of FIG. 7A;

FIG. 7C is a front view in elevation of the front end assembly shown with the stem retracted for a short rider; and

FIG. 7D is a side view in elevation of the front end assembly of FIG. 7C.

### DETAILED DESCRIPTION OF THE PREFERRED EMBODIMENTS OF THE INVENTION

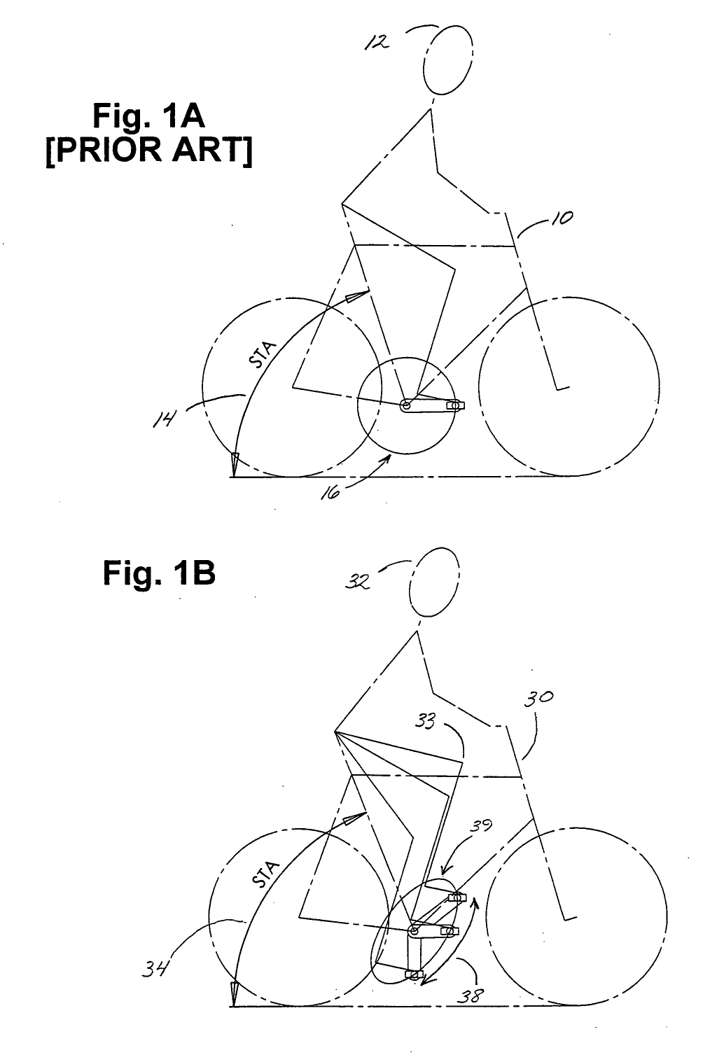

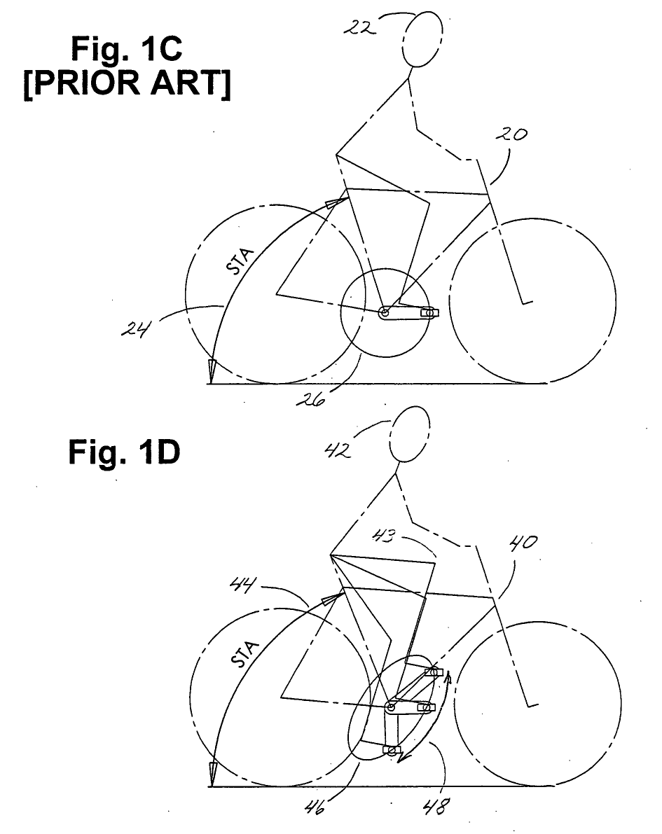

Referring now to FIGS. 1A through 1D, wherein like reference numerals refer to like components in the various views, FIGS. 1A and 1C show prior art bicycles 10, 20, for tall and short riders, respectively, 12, 22, having high seat tube angles 14, 24, and circular pedaling systems 16, 26. As noted in the background discussion, increased comfort and pedaling efficiency require the frame geometry and pedal system combine to increase the distance over which the rider's knee is positioned over the pedal spindle.

FIGS. 1B and 1D are schematic views of bicycles 30, 40 having frame geometries characteristic of the present invention, and showing the desired pedaling feature for tall and short riders, 32, 42, respectively. The objective is accomplished by reducing the seat tube angle 34, 44, to less than 69 degrees and employing a pedaling system having an elliptical pedal path 36, 46, which increases the distance 38, 48 over which the rider's knee 33, 43, remains over the pedal spindle 39, 49.

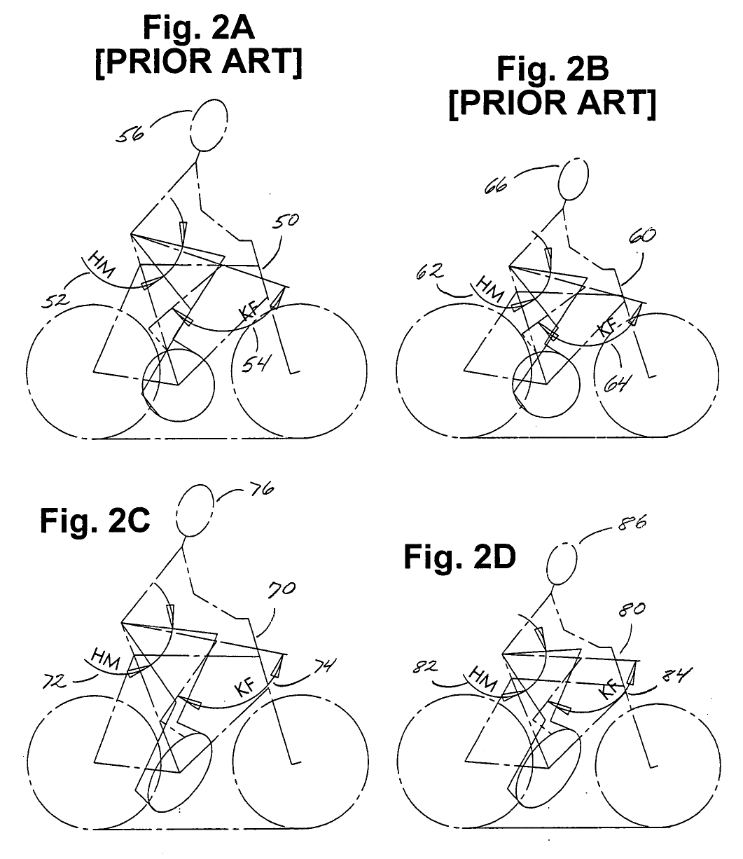

As noted previously, the frame geometries and pedal paths shown in FIGS. 2A, 2B, 2C and 2D, correspond precisely to those of FIGS. 1A, 1C, 1B, and 1D, respectively. FIGS. 2A and 2B again show prior art bicycles 50, 60 employing conventional frame geometries and circular pedaling systems. FIG. 2A shows the hip joint range of motion 52 and maximum knee flex 54 of a tall rider 56. The hip joint range of motion (HM) of the rider in FIG. 2A is 38 degrees, and the maximum knee flex (KF) is 121 degrees. FIG. 2B shows the hip joint range of motion 62 and maximum knee flex 64 of a short rider 66. The small rider in FIG. 2B has an HM of 43 degrees and KF is 128 degrees.

FIGS. 2C and 2D show bicycles 70, 80, having frame geometries and pedaling systems characterizing the present invention, whereby the hip joint range of motion 72, 82, is increased, and the maximum knee flex, 74, 84, are reduced for tall and short riders, 76, 86, respectively. In FIG. 2C, HM is 48 degrees and KF is 114 degrees. It will be appreciated, therefore, that for the tall rider, HM has increased 26 percent, and knee flex has decreased by slightly less than 6 percent. In FIG. 2D, the HM for the short rider is 61 degrees and KF is 125 degrees, increasing hip joint motion 42 percent while decreasing knee flex by over 2 percent.

Accordingly, FIGS. 1B, 1D, 2C and 2D show the biomechanical and ergonomic advantages of the bicycle of the present invention. These views show that the reduced seat tube angle and elliptical pedaling system of the present invention combine to move a rider's center of gravity rearwardly, increase the distance over which the rider's knee remains over the pedal spindle, increase hip joint range of motion, and decrease maximum knee flex.

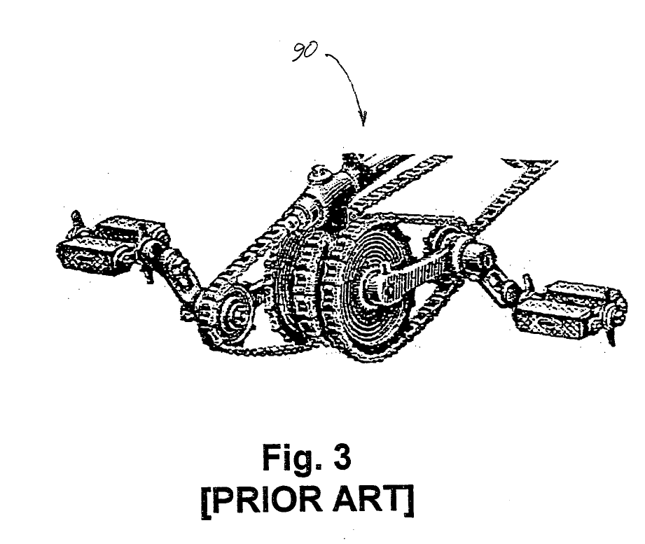

FIG. 3 shows an early prior art elliptical drive mechanism 90 of the kind that inspired developments leading to the innovation of the elliptical drive mechanism of the present invention.

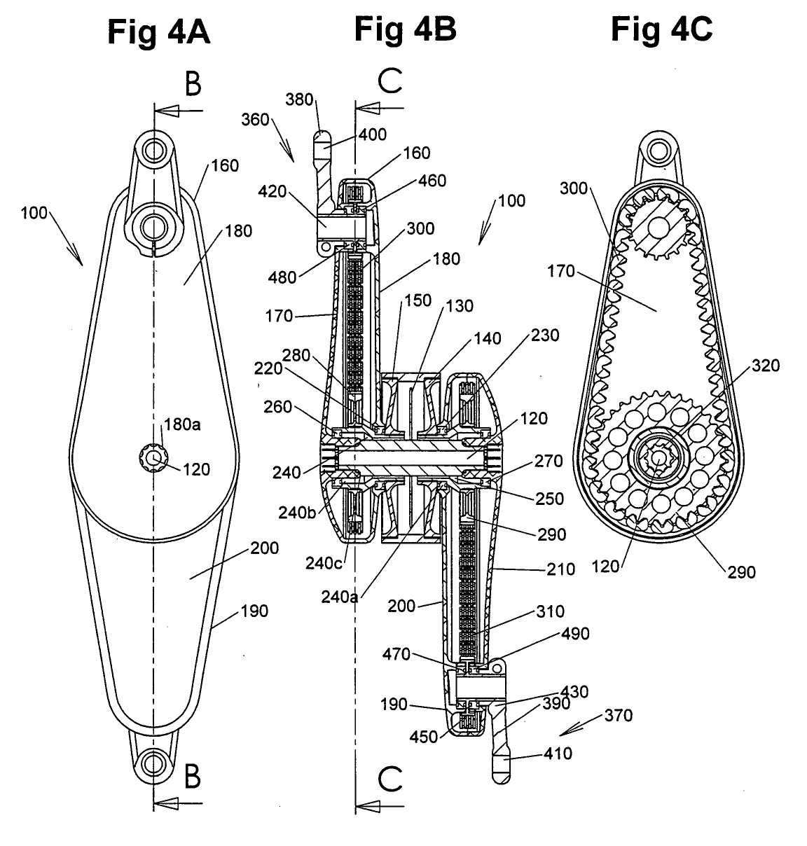

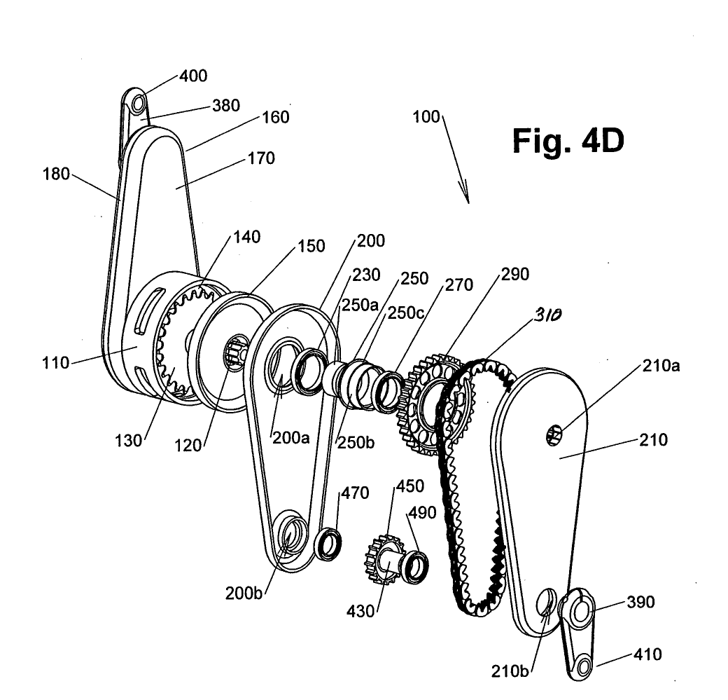

FIGS. 4A-D are various views of the novel elliptical drive mechanism of the present invention. This collection of view shows that the elliptical drive mechanism 100 comprises a cylindrical chain ring housing 110 disposed substantially at the center of the drive mechanism. Rotatably disposed within the chain ring housing is a crank axle 120 having an internal front chain ring sprocket 130 at its center. The chain ring housing is sealed on its sides by first and second bottom bracket adaptor plates 140, 150 which are pressure fit within the interior diameter of the chain ring housing.

Disposed on one side of the chain ring housing is a first crank housing 160, which is formed by a first inner crank housing member 170, and a first outer crank housing member 180. The second crank housing 190 includes second inner crank housing member 200 and second outer crank housing member. The inner and outer crank housings join to form sealed enclosures which also function as the primary crank arms.

First and second inner crank housing members each include a circular opening into which are placed, respectively, first and second inner crankshaft bearings, 220, 230. Bottom bracket extensions 240, 250, each having an inner portion 240a, 250a, and outer portion 240b, 250b, and a middle portion 240c, 250c, are coaxially disposed over the crank axle at each side of the bottom bracket housing, each bottom bracket extension being journaled at its inner portion in an inner crankshaft bearing. The bottom bracket extensions are stationary, or fixed. They bear their name due to the fact that they effectively extend the lateral dimensions of the bottom bracket to accommodate an elliptical drive mechanism employing a stationary sprocket, described fully below.

First and second outer crankshaft bearings 260, 270, are placed within a cylindrical opening within the respective outer portions of the bottom bracket extensions and are coaxially disposed on the crank axle so as to function as outer journals for the crank axle and to facilitate rotation of the crank axle. Accordingly, rotation of the crank housings occurs around the bottom bracket extensions, which rotation of the crank axle occurs within the bottom bracket extensions.

First and second stationary sprockets, 280, 290, are coaxially disposed over the middle portion of the first and second bottom bracket extensions, respectively.

The primary crank arms are completed by first and second synchronous belts or silent chain loops 300, 310, which are in mesh engagement with their respective stationary sprockets. As will be noted, the crank axle includes outboard gear teeth 320, 330, or other male surface structures, which are matably inserted into an opening 180a, 210a, in the outer crank housings, each of which bear complementary female contours.

The elliptical drive mechanism further includes first and second secondary cranks, 360, 370. Each secondary crank includes a crank arm 380, 390, having a hole 400, 410 for the installation of pedals. The crank arms are disposed on first and second input shafts 420, 430, each having an input sprocket, 440, 450. The input shafts are journaled on first and second inner sprocket bearings 460, 470, which are coaxially disposed over the respective input shafts. The inner sprocket bearings are inserted into the outboard opening 170b, 200b, on the inner crank housing member. First and second outer sprocket bearings, 480, 490 are disposed on the input shaft on the opposite side of the input sprocket from the input sprocket bearing. They are inserted into the respective outboard openings 180b, 210b, in the outer crank housing members.

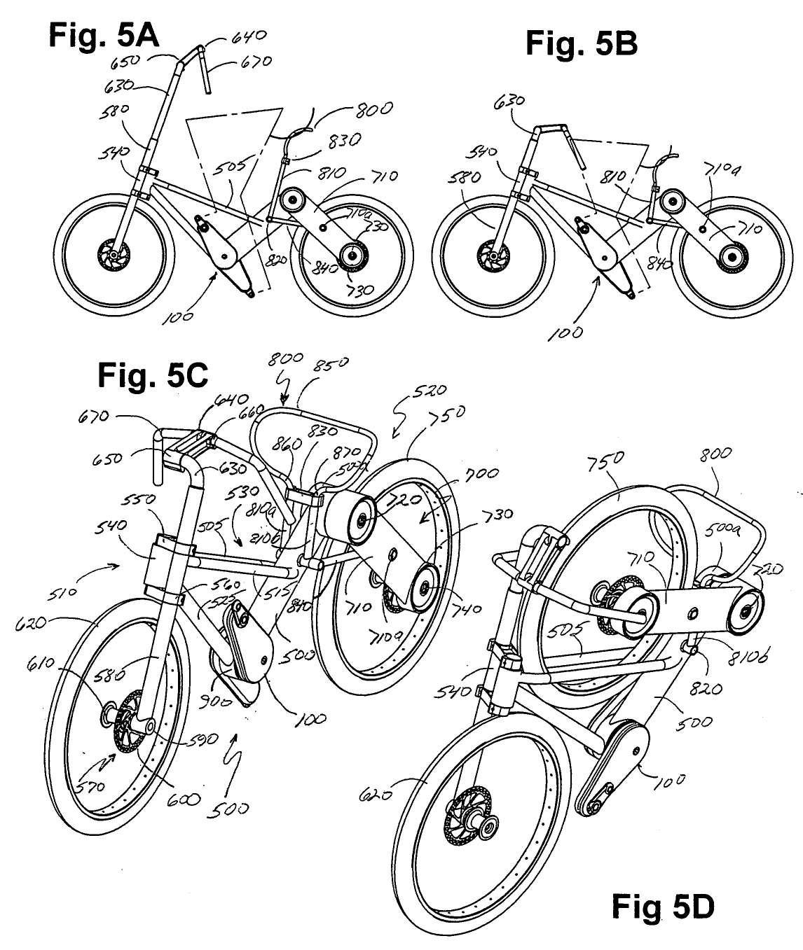

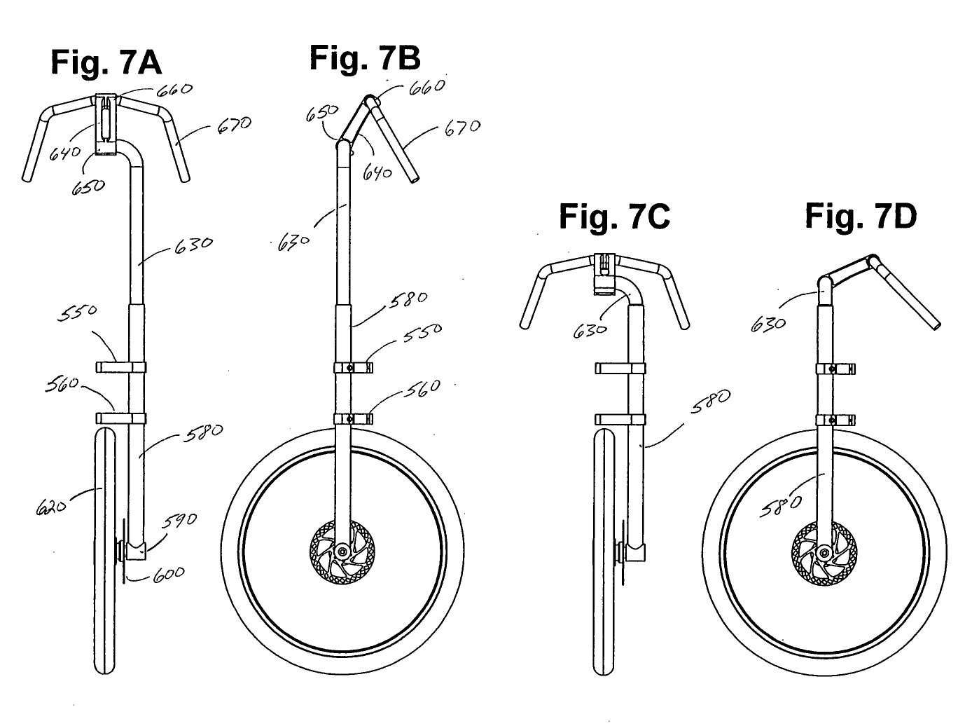

Referring now to FIGS. 5A through 5C, and 7A through 7D, there is illustrated a first preferred embodiment of the inventive bicycle, the primary elements and component sets including a hollow composite material frame including a primary frame member 500, a front portion 510, a rear portion 520, a central portion 530, and a head tube 540. The head tube includes upper and lower locking collars or couplers, 550, 560 for pivotal connection to a front end assembly. Side-by-side top tubes 505, 515, angle downwardly from the head tube to an integral connection with the primary frame member to increase the strength and rigidity of the frame. A down tube 525 angles even more sharply downward from the head tube to connect to the primary frame member through a bottom bracket 900, which is preferably an integral cylindrical expansion formed between the bottoms of both the primary frame member and down tube.

Pivotally clamped onto the head tube by couplers 550, and 560, is a front end assembly 570, comprising a single front steering arm or fork tube 580 having a cylindrical lower end 590 for insertion and capture of one end of a single-sided wheel axle (not shown) supporting a wheel assembly. A disk brake rotor 600 is disposed on the wheel hub 610, and a wheel 620 completes the lower portion of the front end component set. A steering arm quill or steer tube 630 is inserted into the upper end of the fork tube, and a handlebar stem 640 with dual clamp assemblies 650, 660, connects the steer tube and handlebars 670, while allowing adjustment of both at the steer tube and at the handlebars. Upper and lower bearing sets (not shown) are disposed within the couplers 550, 560 to permit turning inputs to be freely transmitted through the steer tube and fork tube to the front wheel.

A rear wheel assembly 700 is coupled to the rear portion 520 of the primary frame member 500. This assembly comprises a rear arm 710 angling downward and rearward and rotatably mounted to the rear portion of primary frame 500 at a mid-drive axle rear arm pivot shaft 720. The rear arm includes a cylindrical expansion 730 at its lower end which has a throughhole 740 for insertion of a rear wheel axle on which is rotatably mounted a rear wheel 750.

A seat 800 is mounted on an inventive articulating seat tube 810 having two vertical seat tubes 810a, 810b, which are in turn mounted on a seat tube mounting shaft 820 extending transversely through the primary frame member 500. Up/down adjustment of the seat is made through a locking collar 830 disposed at the uppermost portion of the vertical seat tubes. A link or stabilizing strut 840 is attached at one end to the seat tube mounting shaft 820 and at the other end to the middle portion 710a of the rear arm 710, preferably by a quick release push-button ball detent pin (not shown). The seat tubes are mounted on the seat tube mounting shaft with an adjustment pin (not shown), well known in the art, in a manner that allows the rider to rotate the position of the seat fore and aft, though other well known means may be employed.

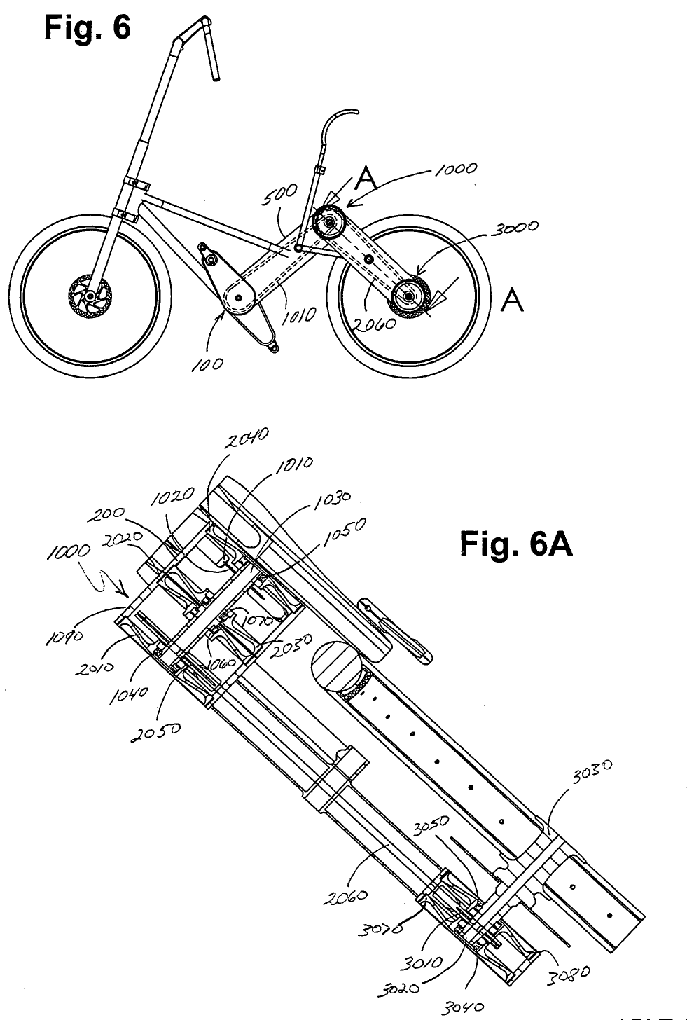

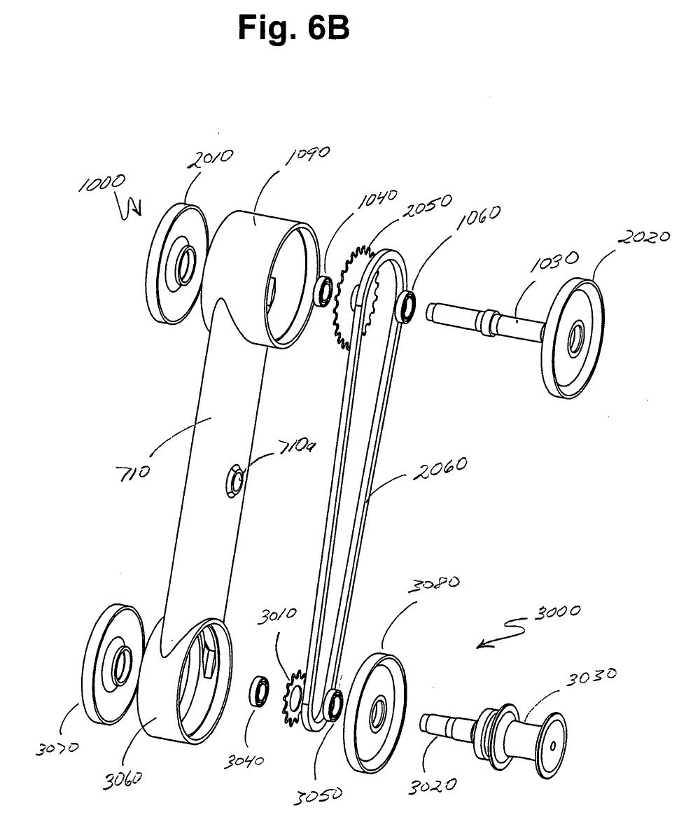

The seat frame member 850 comprises a unitary bent tube or rod which may be covered by a number of suitable materials, preferably including a resilient mesh material as is now commonly employed in office seating. The seat tube 850 forms a concavity that extends laterally outward a distance to exceed the distance between hip joints of the rider, and is dimensioned such that it will accommodate and contain the buttocks of most reasonably sized riders. In profile, the tube arches rearwardly to form a kind of arcuate wall (see esp. FIGS. 5A, 5B and 6). Below the seat portion of the seat tube two vertical seat posts 860, 870 extend downwardly for insertion into the seat tubes. As an alternative, the seat posts can have an interior diameter exceeding the outer diameter of the seat tubes, in which event the seat tubes are actually inserted into the seat posts. The adjustment means for the seat remains the same.

Finally, the elliptical drive mechanism 100 is mounted in the frame bottom bracket 900 in a well known manner.

FIG. 5D shows the collapsible frame in the folded configuration. In order to accomplish the collapse, the upper and lower locking collars 550, 560 of head tube 540 are loosened and the steering arm 580 and front wheel 620 are swung substantially 180 degrees. The handlebar stem 640 locking collars 650, 660 are loosened and the handlebars are swung over the steering arm quill 630. The stabilizing strut 840 is removed by removing the quick relase push-button ball detent pin attached to the middle portion 710a of the rear arm and removing the adjustment pin from the seat post mounting shaft. The seat 800 is either removed or adjusted to its lowest position, and the rear arm 710 is pivoted over the seat so that the rear wheel nests between the head tube 540, the primary frame member 500, and the top tubes 505, 515, and generally rests on the down tube 525 and primary frame member 500.

As will be readily appreciated by those with skill in the art, the use of an elliptical drive mechanism having a centrally driven synchronous belt or silent chain requires a mid-drive to route power around the rear tire and wheel. Accordingly, the present invention employs a novel and elegant mid-drive mechanism that communicates power from the elliptical drive mechanism to a final drive operatively connected to the rear wheel.

FIGS. 6A and 6B show that the elliptical drive mechanism 1000 has a primary drive belt or chain loop 1010 in mesh engagement with the front chain ring sprocket 130 and contained and extending upwardly and interiorly within the primary frame member 500 to a mid-drive input sprocket 1020 coaxially fixed onto a mid-drive shaft 1030. The mid-drive shaft has multiple functions, as it is an element in the power train, a suspension point for the frame, and a pivot point for folding the bicycle.

The mid-drive shaft is journalled on four bearings, two outboard, 1040, 1050, and two inboard, 1060, and 1070, all coaxially disposed over the mid-drive shaft. The assembly is contained within a mid-drive housing 1080, which includes two halves 1090, 2000, pivotally joined over the mid-drive shaft. Preferably, the housing halves comprise integral cylindrical expansions at the respective upper ends of the primary frame member and rear arm. Each half is enclosed at the side with housing covers 2010, 2020, 2030, 2040, which seal the housing and also function as bearing retainers.

Coaxially mounted on and fixed to the mid-drive shaft is a mid-drive output sprocket 2050. Power is transmitted from the elliptical drive mechanism by means of the primary drive belt to the mid-drive shaft. In turn, power is conveyed through the mid-drive output sprocket 2050, through a secondary drive belt or chain 2060, and on to a final drive 3000, which includes a rear wheel sprocket 3010, fixed on a final drive shaft 3020, which is integral with a rear wheel hub 3030. The final drive shaft is journalled on first and second final drive bearings 3040, 3050, and the entire assembly is housed within the final drive housing 3060, which preferably comprises an integral cylindrical expansion at the lower end of the rear arm 710. First and second housing covers/bearing retainers 3070, 3080, enclose the assembly and protect it from contamination.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the present invention should be determined only by the broadest interpretation of the appended claims so as to encompass all such modifications as well as all relationships equivalent to those illustrated in the drawings and described in the specification.

1. A bicycle, including:
a frame including a bottom bracket and a head tube, a primary frame member having an upper end and a lower end connected to said bottom bracket, said primary frame angled relative to the horizontal at less than 69 degrees, a down tube having an upper end connected to said head tube and a lower end connected to said bottom bracket, and at least one rear arm having an upper end and a lower end;
an elliptical drive mechanism coupled to said bottom bracket and including a crank axle having at least one front chain ring sprocket fixed on said crank axle, and further including first means for installing pedals, wherein said elliptical drive mechanism produces an elliptical pedal path during use;
a final drive disposed at said lower end of said at least one rear arm;
a rear wheel operatively connected to said final drive;
a mid-drive interposed between said elliptical drive mechanism and said final drive, said mid-drive disposed at said upper end of said primary frame member and said upper end of said at least one rear arm, said mid-drive having a drive shaft operatively connected to said crank axle of said elliptical drive mechanism and to said final drive with a belt or chain; and
a seat.

2. The bicycle of claim 1, wherein said frame further includes at least one top tube disposed between said head tube and said primary frame member at a point above said bottom bracket.

3. The bicycle of claim 1, wherein said primary frame member is connected to said rear arm at a pivot point and wherein said frame is selectively collapsible.

4. The bicycle of claim 3, wherein said mid-drive drive shaft and said pivot point are collocated.

5. The bicycle of claim 1, wherein said elliptical drive mechanism includes:
a cylindrical chain ring housing disposed substantially at the center of said drive mechanism, wherein said crank axle is rotatably disposed within the chain ring housing;
first and second bottom bracket extensions in fixed relation to said bottom bracket and coaxially disposed over said crank axle;
first and second stationary sprockets disposed on said first and second bottom bracket extensions, respectively;
first and second primary cranks, wherein said first and second primary cranks comprise first and second enclosed crank housings, respectively, each of said primary cranks having an inboard side and an outboard side;
first and second secondary cranks disposed on said outboard side of a respective primary crank and including an input shaft and an input sprocket; and
first and second belts in mesh engagement with and disposed between said first and second stationary sprockets and said first and second input sprockets;
wherein said first and second stationary sprockets, input sprockets, and belts are enclosed within said first and second primary crank housings, respectively.

6. The bicycle of claim 1, further including a front end assembly pivotally connected to said head tube, said front end assembly comprising
a fork tube having an upper end and a lower end;
a single-sided wheel axle disposed at said lower end of said fork tube;
a steer tube inserted into said upper end of said fork tube;
a handlebar stem having first and second clamp means, wherein said first clamp means captures and secures said steer tube; and
handlebars captured and secured in said second clamp means.

7. The bicycle of claim 1, further including:
a seat tube mounting shaft extending transversely through said primary frame member;
an articulating seat tube having two vertical seat tubes mounted on said seat tube mounting shaft and extending upwardly from said primary frame member;
and wherein said seat includes two seat posts, one each inserted into one of said seat tubes.

8. The bicycle of claim 7, further including a stabilizing strut disposed between said primary frame member and said rear arm.

9. The bicycle of claim 1, wherein said seat includes a frame member fabricated from a unitary bent tube.

10. The bicycle of claim 1, wherein said bicycle has a collapsed configuration, and wherein when in the collapsed configuration said rear arm pivots over said seat so that said rear wheel nests between said head tube and said primary frame member.

11. An elliptical drive pedal apparatus for a bicycle having a frame, said elliptical drive pedal apparatus having an elliptical pedal path to increase the distance over which a rider's knee remains over the pedal spindle, said elliptical drive pedal apparatus comprising:
a crank containing a synchronous belt portion and a belt sprocket, said belt sprocket positioned proximate the center of the bicycle frame.

12. The pedal apparatus of claim 11 wherein the bicycle frame includes a seat tube having an angle of less than 69 degrees relative to the horizontal.

13. The pedal apparatus of claim 11 wherein said belt sprocket is connected to a mid-drive to align a chain to a desired chain line.

14. The pedal apparatus of claim 11 wherein said crank includes a crank axle rotatably disposed within a sealed chain ring housing.

15. The pedal apparatus of claim 11 including inner and outer crank housings join to form sealed enclosures which also function as primary crank arms.

16. The pedal apparatus of claim 11 including bottom bracket extensions coaxially disposed over a crank axle, each bottom bracket extension being journaled at its inner portion in an inner crankshaft bearing.

17. The pedal apparatus of claim 11 including first and second outer crankshaft bearings placed within a cylindrical opening within the respective outer portions of bottom bracket extensions, and coaxially disposed on the crank axle so as to function as outer journals for the crank axle and to facilitate rotation of the crank axle, wherein rotation of the crank housings occurs around the bottom bracket extensions, while rotation of the crank axle occurs within the bottom bracket extensions.

18. The pedal apparatus of claim 17 including first and second stationary sprockets coaxially disposed over a middle portion of said bottom bracket extensions.

19. The pedal apparatus of claim 17 including first and second synchronous belts in mesh engagement with respective stationary sprockets.

20. The pedal apparatus of claim 17 including first and second secondary cranks each including a crank arm for installation of pedals, said crank arms disposed on input shafts having an input sprocket.

21. The pedal apparatus of claim 11 including a primary frame member having a front portion, rear portion, central portion, a head tube having upper and lower locking collars, side-by-side top tubes angled downwardly from said head tube to an integral connection with the primary frame member, and a down tube angled downward from said head tube to connect to said primary frame member through a bottom bracket.

22. The pedal apparatus of claim 21 including a front wheel assembly rotatably inserted into said head tube, said front wheel assembly including a front steering arm having a cylindrical lower end for insertion and capture of one end of a wheel axle.

23. The pedal apparatus of claim 22 including a steering arm quill inserted into the upper end of said steering arm, and a handlebar stem connecting said quill and handlebars.

24. The pedal apparatus of claim 21 including a rear wheel assembly coupled to the rear portion of said primary frame member, said rear wheel assembly including a rear arm angling downward and rearward and rotatably mounted to the rear portion of said primary frame at a mid-drive axle rear arm pivot shaft.

25. The pedal apparatus of claim 24 wherein said rear arm includes a cylindrical expansion at its lower end which has a throughhole for insertion of a rear wheel axle.

26. The pedal apparatus of claim 11, further including a seat mounted on an articulating seat post having two vertical support tubes mounted on a shaft extending transversely through a primary frame member.

27. The pedal apparatus of claim 26 wherein said seat post is mounted on said shaft with an adjustment pin to allow the rider to rotate the position of the seat fore and aft.

28. The pedal apparatus of claim 26 wherein said seat comprises a unitary bent seat tube covered by a resilient mesh material.

29. The pedal apparatus of claim 26 wherein said seat forms a concavity that extends laterally outward a distance to exceed the distance between hip joints of the rider.

30. The pedal apparatus of claim 11 wherein the bicycle frame is collapsible to a folded configuration.
